(19) United States
(12) Patent Application Publication
(10) Pub. No.: US 2024/0256686 A1
(43) Pub. Date: Aug. 1, 2024

(54) METHODS AND APPARATUS FOR INTERFERING WITH AUTOMATED BOTS USING A GRAPHICAL POINTER AND PAGE DISPLAY ELEMENTS

(71) Applicant: SunStone Information Defense, Inc., Jamestown, OH (US)

(72) Inventor: David K. Ford, Jamestown, OH (US)

(21) Appl. No.: 18/425,624

(22) Filed: Jan. 29, 2024

Related U.S. Application Data
(60) Provisional application No. 63/441,676, filed on Jan. 27, 2023.

(51) Int. Cl. G06F 21/62; G06F 3/0346

(52) U.S. Cl. CPC G06F 21/62; G06F 3/0346; G06F 2221/2103; G06F 2221/2137

(57) ABSTRACT

Methods and apparatus for interfering with automated bots using a graphical pointer and page display elements are disclosed. In an example, a processor selects a challenge for display on a client device. The challenge includes a display element and stylized pointer information. The processor causes the display element to be displayed on the client device and a pointer to be stylized, as specified by the pointer information. The processor receives a response message corresponding to at least one of a pointer selection or pointer movement made by the stylized pointer. The processor compares information within the response message to a specified correct location of the display element that is stored in an answer file related to the selected challenge. If the information within the response message is correct, the processor transmits a correct answer message and/or enables webpage content to be displayed or otherwise provided to the client device.

### PRIORITY CLAIM

This application claims priority to and the benefit of U.S. Provisional Patent Application No. 63/441,676, filed on Jan. 27, 2023, the entirety of which is incorporated herein by reference.

### BACKGROUND

A pointer is one of the most ubiquitous aspects of computing. It is displayed as a graphic that changes locations within a display area based on inputs received from a mouse or similar input pointing device. Pointer properties, such as appearance and movement characteristics, are defined within a pointer file or specified in application code or code that is supplied by a third-party that operates in the application. The pointer properties are used by an operating system or application of a computer to display/move a pointer on a screen or within a display area. The pointer file also defines a “hot spot”, which includes an active pixel or a group of pixels within a pixel area for the pointer graphic. Selection of a pointer causes a location or coordinates of the hot spot to be returned as the selected location on a screen.

Currently, some websites provide a test to determine whether a user is a human or a computer (e.g., an automated bot). The test may include a completely automated public Turing test, a test of a machine's ability to exhibit intelligent behavior equivalent to, or indistinguishable from, that of a human, for differentiating computers from humans. One such Turing test is known as a Completely Automated Public Turing test to tell Computers and Humans Apart (“CAPTCHA”). Websites use CAPTCHAs as a security feature for providing accessing to a database, submitting a search query, purchasing a product/service, viewing requested content (e.g., multimedia content), etc.

Common CAPTCHAs today include a display of different pictures in a grid. A prompt instructs a user to select squares or fields in the grid that contain certain items, such as cars, bicycles, sidewalks, traffic signals, trees, buildings, etc. Many times the items are not clearly visible within the picture. The goal of the CAPTCHA is to provide images that are easily recognizable by a human user but difficult for a computer or bot to quickly decipher. For instance, a human user instantly understands what a car looks like and can identify images that contain cars, including images where the car is partially blocked from view or shown at various angles. In contrast, a computer has to apply one or more computer-vision or machine-learning algorithms that compare different profiles of cars to different items in the image to identify potential matches. Oftentimes, a computer or bot is not able to adequately identity all of the squares in a grid that contain a specified item, or at least make an identification within a reasonable time to pass the CAPTCHA.

More sophisticated Turing tests can differentiate human users from automated bots by simply prompting a user to select a box. The pointer speed, movement path, and pointer selection location with respect to the box area are compared to patterns (for the same page layout and features) associated with human users and patterns associated with automated bots. Human users engage with the page's geometry and content guided by real-time comprehension of the details and meaning of currently rendered iconography and features. This real-time comprehension of the significance of their interactions with the page tends to be reflected in the details of the user's pointer movements as the user acts to complete an intended task creating patterns of typical use. Additionally, the human user's control over the user interface (“UI”) device (for example a “mouse”) is constrained by the realities of the actual physical device such as the presence or absence of a mousepad, the presence or absence of a mouse cable, the size of a trackpad, the diameter of a trackball style mouse, etc. In comparison, automated bots do not experience the UI devices physically but rather simply guide the device programmatically and/or mathematically by providing abstract input data as events into, for example, the OS, and are unaffected by the physical considerations of the input device.

Overtime, bot designers optimize bots to improve Turing test performance. Bot designers have easily increased computing power, especially in distributed environments, to decrease the time needed to solve Turing test challenges in a manner that resembles human movement, for example, by simply recording and replaying human movements for a given page. In addition, bot designers have refined machine-learning algorithms to include artificial intelligence components that provide more accurate and faster completions of turning tests that mimic human users. For example, a popular test features a fixed grid of nine images. A user is asked to identify images within the fixed grid. Although the location of the correct images within the grid may change, the containment grid itself does not. The human versions of physically driving the UI device, selecting an answer from box 1, box 2 box3, etc. may simply be recorded and the decision of which grid element to select may be made by the AI engine at which time the human motion for that grid element is simply replayed. As a result of the bots improvements, currently known Turing tests may not be adequate.

### SUMMARY

The present disclosure provides a new and innovative system, method, and apparatus for detecting or interfering with bots or other automated malicious applications using a graphical pointer or icon in conjunction with displayed page elements. The example system, method, and apparatus are configured to provide a challenge or Turing test to a user of a webpage, application, database, etc. The Turing test is relatively easy for a user to answer but extremely difficult or impossible for a computer or automated bot to solve within a relatively short amount of time in a manner that would resemble human movement.

The Turing test disclosed herein includes a challenge for a webpage or application displayed by a client device, such as a smartphone or a tablet computer. The turning test prompts a user to tilt the client device in a certain manner to move the pointer or icon to a certain target location (e.g., a pointer hot spot). The movement of the pointer is configured as though the pointer is being pulled downward by gravity such that the angular orientation of the client device dictates the movement of the pointer. Data from one or more angular acceleration sensors and/or linear acceleration sensors within the client device can be used to confirm that the client device was tilted as intended to reach the specified target location. In some embodiments, the sensitivity of the Turing test may be varied between sessions to make it more difficult for an automated bot to leverage pre-recoded human input data.

In some instances, the Turing test can change how the data from the one or more angular acceleration sensors and/or linear acceleration sensors is associated with movement of a pointer. For example, the Turning test can reverse the correspondence between tilt and pointer movement so a user would have to tilt a client device in an opposite manner to move the pointer as intended. Additionally or alternatively, the Turing test can change the movement speed based on a distance from a target location and/or a location on a screen of a client device. This movement change might make the test appear more ‘jerky’ to a user and make it more difficult for a bot to solve. In an example, the Turing test can specify that a pointer is to move slower as it approaches a target location despite the client device having a same tilt or linear movement. In other examples, the correspondence may vary over time or between sessions.

In some embodiments, the Turing test disclosed herein includes the use of a pointer file that changes an appearance of a pointer from an arrow to a graphical representation of another object. Examples include a soda can, a beer bottle, a game controller, sunglasses, a hat, a bird, a dog, etc. As one can appreciate, the examples of graphical representations are virtually endless. The Turing test also includes or specifies a page display element, such as a picture, animation, or video. The page display element is configured to have coordinates or other location information. For a given challenge, the example system, method, and apparatus determine coordinates that satisfy or solve the challenge and coordinates that correspond to an incorrect answer. The coordinates for solving a challenge for a given display element are selected beforehand based on the image or video selected for display, and how display element relates to the graphical representation of the pointer.

The display element, as disclosed herein, may include a scenery picture, a picture of a person, such as an actor or musician, a picture of multiple people, etc. Again, as one can imagine, the possibilities for a display element are virtually endless. The display element may be selected in coordination with the graphical representation of the pointer and a challenge provided to a user. The challenge includes one or more instructions that requests a user to move the pointer to a certain location on a display element. The requested location is configured to be easily discernable by a user but extraordinarily difficult for a bot or malicious application to answer. The challenges represent real-time comprehension of UI device input and output effects and acquired internal human knowledge that is not easily parameterized by a computer.

In an example, the system, method, and apparatus may select a display element of a musician with their arms outreached. For this display element, a system operator (or a configuration server) created a challenge by changing a pointer file to show a soda can pointer, and specifying a textural prompt to “Give the musician a soda”. The operator or server determines that an allowable or correct response comprises a pointer hot spot that is on or around one of the hands of the musician that is shown in the display element. Human users are quickly able to understand the challenge and accordingly tilt their client device in a matter of seconds so that the soda can pointer is moved to the musician's hand, which is shown in the display element. By contrast, a computer or bot has to first determine what the prompt even means before being able to determine which items in the display element are to be located. The bot also has to determine what item the graphical representation of the pointer represents as part of the solution for the challenge. Further, the computer or bot has to determine what sensor data is needed to indicate tilt in a certain direction. Altogether, a computer or bot may need at least 5 minutes to multiple hours to solve the challenge, which would far exceed website timeout thresholds for receiving an answer. As an additional benefit of the disclosed process, even in situations where security concerns may be secondary, the seemingly simple act of having a user interact with a virtual representation of their favorite musician by causing a soda can or other graphical icon to move into the celebrity's hand forms psychological and perhaps neurological connections for that user between the musician and the soda brand.

The example system, method, and apparatus may further complicate the challenge for a bot by causing at least portions of a display element to change in response to a pointer hover or movement. For example, the system, method, and apparatus may cause at least a portion of a display element to zoom in, zoom out, animate, change to a different displayed element, change in perspective, change a display of an item within the display element, and/or uncover or make transparent a first image or color to reveal an underlying image. The change in display of at least a portion of the display element is readily discernable by a user but extremely difficult for a bot or other malicious application to process.

As botnets need not actually rely on a visible (to the human) display but rather base their logical actions on computed programmatic information contained within the presentation of transactional data, changes to un-displayed programmatic information may also be varied to interrupt the predictability of the bot's problem solving environment. Further, pointer movement can be tracked to determine if the movement is within established patterns of human usage for a given layout, task, and UI control parameters (how much angle of tilt is required for a given movement in terms of pixels) indicative of a human user or a brute force pixel by pixel row by row scanning pattern or more sophisticated other pattern aided by the inclusion of AI, which is indicative of a bot. In many applications, the ultimate output of the transmitted information is visual. However, sometimes the ultimate presentation to the user may be non-visual, for example, an audible pitch or sequence of pitches, a tactile vibration, etc. that the user, through the user input mechanism is able to control and/or recreate.

Additional features and advantages of the disclosed system, method, and apparatus are described in, and will be apparent from, the following Detailed Description and the Figures.

### BRIEF DESCRIPTION OF THE FIGURES

The accompanying drawings, which are incorporated in and constitute a part of this specification, show certain aspects of the subject matter disclosed herein and, together with the description, help explain some of the principles associated with the disclosed implementations.

FIG. 1 illustrates an example of a pointer within a pixel image file representative of a type of image file painted by an operating system onto a monitor of a client device.

FIGS. 2 to 5 illustrate diagrams of an input device security environment, according to example embodiments of the present disclosure.

FIGS. 6 to 9 show diagrams of a Turing test, according to an example embodiment of the present disclosure.

FIG. 10 shows a diagram of a user interface that is displayed after a Turing test has been successfully completed, according to an example embodiment of the present disclosure.

FIG. 11 illustrates a diagram a database configured to store challenges for the input device security environment of FIGS. 2 to 5, according to an example embodiment of the present disclosure.

FIG. 12 is a flow diagram illustrating an example procedure to administer a challenge to a client device, according to an example embodiment of the present disclosure.

### DETAILED DESCRIPTION

Reference is made throughout to the term “pointer”. A pointer is specified by a pointer file (or application code) that defines how a symbol or a graphic image is to be displayed within a pixel area on a computer screen to mirror or echo movements of a pointing device. More generally, the pointer is the object resident as software, firmware, or even hardware that resides in the hardware hosting the application (typically a laptop, phone, smartwatch, etc.) which is able to be controlled by a user through user interface tools such as a mouse, trackpad, touch screen, voice control, microphone, phone tilt angle, NFC antenna, etc. A pointer file or application code includes properties that specify appearance information, such as shape, color, size, shadow, etc. A pointer file or application code also includes properties that specify movement information, such as responsiveness, lag, inversion, etc. A pointer file or application code may further define a pixel location or set of pixels (a relative location within an image file, for example) that comprise a hot spot.

Reference is also made throughout to a pointer selection and pointer position. As disclosed herein, a pointer selection corresponds to an activation of an actuator of a pointing input device, such as a left or right-click of a mouse (mouse “hovering”—the marked absence of motion for a period of time is another type of selection). A pointer selection corresponds to a hot spot location on a screen or within an application viewer. A pointer position corresponds to a location of a pointer on a screen or within an application viewer. A position of a displayed pointer may not necessarily be the same location as a hot spot if an offset is created between the displayed pointer and the hot spot.

Reference is further made throughout to the term “mouse”. A mouse includes a pointing input device that enables a user to specify a location of a pointer on a screen. The mouse may include a hardware device such as a touchpad, trackball, stylus pen, etc. The mouse may also include a touchscreen that enables a user to change a position of a pointer to enter mouse-like selections. The mouse may further include a virtual mouse that may include software that emulates mouse movement. For example, the virtual mouse may include a virtual track ball that is displayed within a touchscreen of a client device. The virtual track ball enables a user to move a pointer, including a stylized pointer within an application viewer by selecting different locations or sliding their finger along the track ball. While the user's finger is located at the track ball, the hot spot for pointer selection corresponds to the pointer location or a location that is an offset from the pointer.

### Client Device Tilt Embodiments

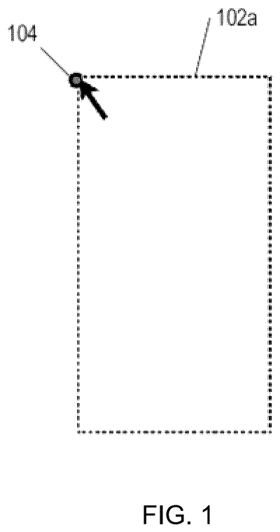

In some embodiments, the method, apparatus, and system are configured to interfere with automated bots (e.g., malware) using a pointer in addition to Turing tests described herein. FIG. 1A shows a diagram of a pointer data file 102a, which includes hot spot 104. The data file 102a includes a pixel area of 32×64 pixels. However, the viewable portion of the pointer itself may only comprise a portion of the pixel data, while the other portions are made transparent or hidden from view. The hot spot 104 is by default, typically defined to be the (0, 0) coordinate of the image. An operating system of a computer receives movement information from an input device and changes a position of the image file accordingly to reflect the user's movement.

At the time of a click event, the operating system of the computer identifies a location (e.g., screen or window coordinates) of the hot spot within the display area. The operating system then transmits the coordinates to an application that corresponds to the click event. The application executes program code based on a function defined at the coordinates of the click event.

Unbeknownst to many people, pointers can be manipulated remotely or locally by malware or malicious applications. Oftentimes, malware or malicious applications attempt to access secure webpages or data repositories by injecting pointer movement commands (e.g., commands designed to appear to originate from a pointing device) in connection with keyboard commands to an operating system of a computer or application on a server. In other words, the malware or malicious applications provide commands as though a user was entering commands through a trusted or validated computer as a way to access secure information. The malware or malicious application may be present on a user's computer or be located on a network and configured to intercept network traffic.

The example method, apparatus, and system are configured to generate a pointer for a portable client device for use with a touchscreen. example method, apparatus, and system use angular acceleration data from one or more inertial sensors or acceleration sensors to determine, for example, an orientation of a mobile client device and how long the mobile device has been orientated in a certain manner. The data from the one or more inertial sensors or acceleration sensors is used to move the pointer so that it appears, for instance, the pointer is being pulled by gravity or another force in a certain direction. In other instances, the tilt of the client device defines the direction to which the pointer is to be moved.

The method, apparatus, and system are configured to record a path of travel of the pointer to reach a specified hot spot. This path of travel is configured to take into account and be consistent with the variable sensitivity (per session or within session variability) of the pointer travel distance in pixels to phone rotation angle. The path of travel is also consistent with a human user's real-time reactions to the visible and/or non-visible effects described herein. The method, apparatus, and system may also record a duration of time during which the movement of the pointer occurred. The path of travel, ending location, and/or the duration of time may be compared to thresholds or acceptable ranges of movements carried out under similar UI sensitivity settings to determine whether the Turing test has been successfully completed.

In some embodiments, the method, apparatus, and system disclosed herein are configured to operate on a client device. In these embodiments, the method, apparatus, and system create and apply the Turing test locally for an application before application information is rendered. For example, the method, apparatus, and system may include a plug-in for a web browser or be configured as a stand-alone application. The method, apparatus, and system may also validate the user input locally. The method, apparatus, and system may transmit application data associated with the pointer movement to a hot spot to a server or host of the application if the pointer selection is deemed valid. Additionally or alternatively, the method, apparatus, and system may enable the application data associated with the pointer movement to be provided to the application for local processing. The example method, apparatus, and system may further cause an alert or alarm to be displayed at the client device (or transmitted in a message to an application server) indicative that a pointer movement has been deemed invalid and/or a malicious application may have made the pointer selection.

In some embodiments, the method, apparatus, and system are configured to operate remotely from a client device. For example, the method, apparatus, and system may be configured within a proxy server between an application server and a client device. In other examples, the method, apparatus, and system are configured as a security feature within an application server. In these examples, the method, apparatus, and system are configured to generate and apply the disclosed Turing test to the application (e.g., a webpage) before transmission to the client device. In addition, the method, apparatus, and system may update a pointer definition in the application code and/or remotely update the pointer file for applying the pointer Turing test. Further, the method, apparatus, and system are configured to receive responses from the client device including a location where a pointer was moved to determine if the Turing test was completed successfully. When valid, the method, apparatus, and system may transmit the application or page response information to the application server. When the response is invalid, the method, apparatus, and system may transmit an alert and/or alarm to the application server indicative of a presence of malware or a malicious application.

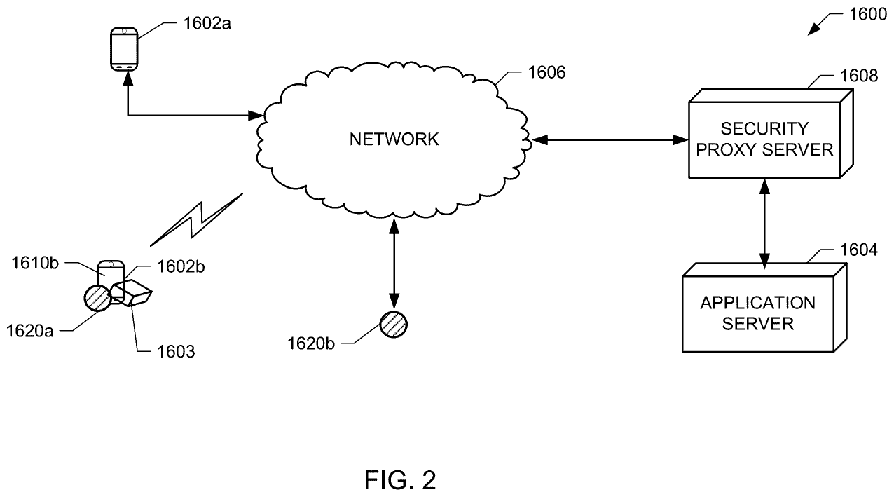

FIG. 2 illustrates a diagram of an example input device security environment 1600, according to an example embodiment of the present disclosure. In the illustrated example, client devices 1602 are communicatively coupled to an application server 1604 via a network 1606 and a proxy server 1608. The client devices 1602a and 1602b may include any smartphone, tablet computer, or other device that includes accelerometers and/or inertial sensors 1603, etc. The client devices 1602a and 1602b may include one or more input devices such as a mouse and/or a touchscreen 1610b.

The example application server 1604 is configured to provide or host any application, website, multimedia content, social media information, etc. The network 1606 may include any network such as the Internet or a local area network. In some embodiments, the application server 1604 may communicate with an application operating on the client device 1602. For example, the application server 1604 may host a website that is displayed within a web browser on the client device 1602. In other embodiments, the application server 1604 includes one or more application programming interfaces (“APIs”) connected to processors and the client devices 1602 include an application (e.g., an App) that is configured to communicate with the APIs.

The example security proxy server 1608 is configured to receive data transmitted from the application server 1604 to the client devices 1602. The data may include, for example, application code, such as website code or data transmitted to an application. As disclosed herein, the security proxy server 1608 is configured to add a Turing test. For instance, the security proxy server 1608 may add a Turing test webpage that must be successfully completed before navigating to another webpage or completing a transaction.

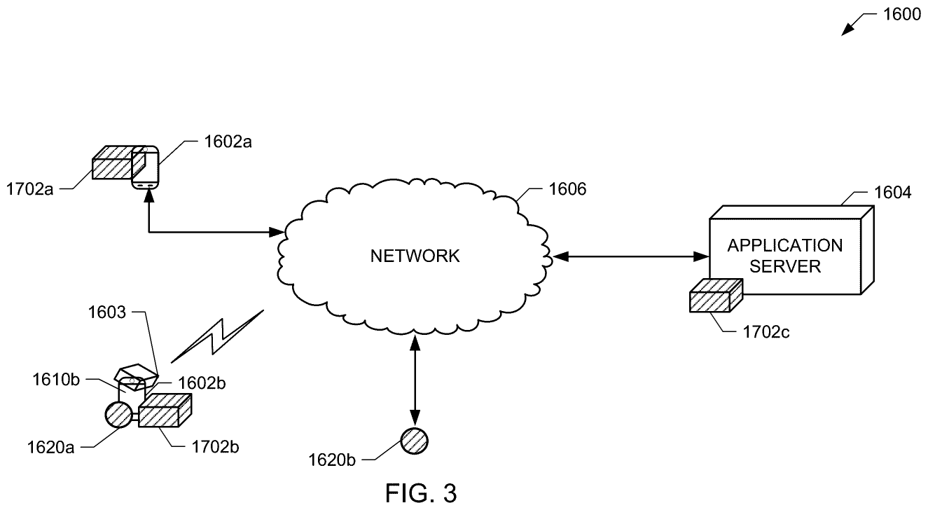

The security proxy server 1608 may be configured to add any type of application code for the Turing test including, for example, TypeScript, eXtensible Markup Language (“XML”), HyperText Markup Language (“HTML”), JavaScript, Cascading Style Sheet (“CSS”), and/or other script-based language that is compatible with a web browser or other user interface-centric application. In some embodiments, the proxy server 1608 may cause a security application to be installed on the client device 1602, as shown in FIG. 3. The security application may include, for example, a browser plug-in, applet, or other program configured to perform the operations described herein.

FIG. 2 also illustrates malware or malicious applications 1620. The malware 1620 may 1620 may be embedded on the client device 1602a and/or connected to the network 1606b. The malware 1620 may locally attempt to provide inputs to access data from the application server 1604. The malware 1620 may analyze network traffic to provide inputs to access data from the application server 1604. In some instances, the malware 1620b may send instructions to the malware 1620a on the client device 1602b providing automated or manual control to access data from the application server 1604.

In some embodiments, the application server 1604 transmits website code or application code to the client device 1602. At least some of the code may include a call or link to the security proxy server 1608 that causes a message to be transmitted when the code is executed. The message may include a request for a Turing test. In some embodiments, the message may identify a model of the client device 1602, an operating system, a screen size, a browser type, etc., which may be used to structure the Turing test for the particular client device 1602. The information in the request message may also be used to determine or modify an answer file based on model of the client device 1602, an operating system, a screen size, a browser type, etc. In response to the message, the security proxy server 1608 provides at least the Turing test, and may also provide an answer file. The Turing test may be displayed as part of a webpage or application page, where navigation to a subsequent page or completion of a transaction is not conducted until a Turing test success message is received via an application on the client device 1602 or the security proxy server 1608. Alternatively, the security proxy server 1608 may receive additional messages from the client device 1602 as responses to the Turing test. The information within the messages is evaluated by the security proxy server 1608 against the answer file to determine when the challenge is completed successfully.

As disclosed throughout, the example security proxy server 1608 is configured to apply one or more Turing tests to prevent the malware 1620 from being able to interact with an application or webpage. The malware 1620 attempts to use pointer or screen coordinates, as determined by an operating system of the client device 1602 to move to a designated application element, such as a “Submit” button. However, the Turing test includes tilt ranges and/or time durations to define a movement path. The tilt ranges correspond to data output by the inertial and/or acceleration sensors 1603. As a result of using the tilt data, the malicious application 1620 is unable to direct the pointer to the function that provides functionality for the “Submit” button, and is prevented from maliciously accessing the application server 1604. Even in the event of a sophisticated malware script or toolkit that is able to successfully determine the imagery of the Turing test, the malware is unable to control the pointer movement (which may vary across sessions and even within a session), and for this reason fails to complete the challenge.

The security proxy server 1608 may also be configured to process responses from the client devices 1602. The security proxy server 1608 may analyze a response to determine if a pointer path, end location, and/or hot spot corresponds to a location of a function (e.g., a hidden application element), a security element, or the displayed application element. Selection of the function or stopping movement of the pointer at the function is indicative that the user is legitimate, which causes the security proxy server 1608 to validate the selection and pass the response information to the application server 1604. Selection of and/or a reaction to (e.g. a path deviation) a security element or the displayed application element is indicative of malware and causes the security proxy server 1608 to block or prevent the response from being transmitted to the application server 1604. In some embodiments, the security proxy server 1608 may generate and transmit an alarm and/or an alert to the application server 1604 that is indicative of the malware. In response, the application server 1604 may block the client device 1602 and/or transmit a message notifying a user of the malware.

FIG. 3 shows an alternative embodiment where the application server 1604 is connected directly to the network 1606 and the proxy server 1608 is replaced with a security application 1702 that is installed on the client device 1602. The application 1702 may include a plug-in to a web browser, a stand-alone application, a proxy for the client device, etc. In the illustrated example, the security application 1702 is configured to provide the Turing test after it is received in the client device 1602 from the application server 1604. The application 1702 may modify the Turing test prior to display on an application or within a web browser. The application 1702 may also modify soft information related to application elements. The application 1702 may also modify a visual appearance of an operating system pointer specified for an application as disclosed herein.

Similar to the security proxy server 1608 of FIG. 2, the security application may also be configured to process responses from the client devices 1602. Before transmission across the network 1606, the security application 1702 may analyze a response to determine if a pointer path, end location, and/or hot spot corresponds to a location of a function (e.g., a hidden application element), a security element, or the displayed application element. Selection of the function or stopping movement of the pointer at the function is indicative that the user is legitimate, which causes the security application 1702 to validate the selection and transmit the response information to the application server 1604. Selection of a security element or the displayed application element is indicative of malware and causes the security application 1702 to block or prevent the response from being transmitted to the application server 1604. In some embodiments, the security application 1702 may generate and transmit an alarm and/or an alert to the application server 1604 that is indicative of the malware. In response, the application server 1604 (or the security application 1702) may block the client device 1602 and/or transmit a message notifying a user of the malware.

In the embodiments of FIGS. 2 and 3, the malicious application 1620 may include an automated bot that is local to the client devices 1602, a bot that remotely accesses the devices 1602, or a bot that remotely accesses the application server 1604. In an example, the malicious application 1620 may include one or more bots configured to access a website to purchase a large volume of popular products or services for resale to customers at a significantly higher price. In other examples, the bot may include a malicious application configured to conduct a distributed denial of service attack on a website or database.

The security proxy server 1608 (and/or the security application 1702) is configured to select one or more Turing tests or challenges for webpages, databases, applications, etc. The challenges are configured to verify a user is a human user rather than a bot or malicious application. The challenges are designed to be solved relatively easy (e.g., within one to twenty seconds) by a human user but be difficult for a computer or bot to understand and solve. For example, the challenges are designed such that it takes a computer or a bot as much as 30 minutes to a few hours to solve.

In an example, the security proxy server 1608 selects a challenge for display on the client device 1602. The challenge may be displayed within a webpage, a popup window, an application, etc. To provide the challenge, the security proxy server 1608 is configured to select at least one display element file, a pointer file, and/or a challenge message file. The challenge may be associated with an answer file that includes, for example, coordinates corresponding a correct selection or answer and/or a range of acceptable movement paths (as provided by the sensor tilt data). The challenge may also be associated with a response time threshold and/or a click threshold.

In some embodiments, the answer file may be determined based on, for example, secondary information, characteristics of the client device 1602, and/or history information as to how other human users answered the challenge or similar challenges. The characteristics of the client device 1602 may relate to types of inertial and/or linear acceleration sensors used for the client device 1602, screen size, browser type, operating system type, etc. The history information may be determined from known human users solving the same or similar challenge. The history information may also be based on outputs of one or more machine learning algorithms that classify human movement and automated bot movement based on trained examples.

As disclosed herein, a display element includes multimedia content that is viewable or otherwise playable on a webpage, application, database, etc. The display element may include one or more images, video, audio, etc. The display element is configured to have coordinates of selectable (or target) locations within, for example, an image. The coordinates may be dimensioned to correspond to a pixel size or configured to be more granular, such as a group of pixels or a size dimension. In some examples, a grid or matrix may be used instead of coordinates, where different rectangles (or other shapes) of the grid correspond to an identifier or coordinates that are returned to the security proxy server 1608 when selected by a pointer.

The display element includes one or more items shown within the multimedia content. The items may include people, animals, characters, scenery, vehicles, etc. There is virtually no limit to the types of items that may be provided within an image. In some examples, the images may be photographs or pictures that are created specifically for the challenge, where one or more items are included from other image files. The display element file may include, for example, a .jpeg image, a .tiff image, a gig image, a bmp image, etc.

In some embodiments, the display element may include or be specified by a multimedia file, a java file, or other plug-in that provides user-interaction within a webpage, application, or database. The display object may include instructions that cause at least part of the displayed items to change in response to pointer movement, such as a mouse-over or hover. For example, coordinates of a pointer position may be used to determine which portion of a display element are to be enlarged or made smaller (e.g., zoom out) or otherwise cause a portion of the displayed element to change in appearance. In an example, an animation may be displayed in response to a mouse-over. In another example, a portion of a first image within a display element may be made transparent or replaced by a second image in response to a mouse-over. For instance, a hover by a pointer may cause an arm of a person to change locations or appear to move. In another instance, a hover by a pointer may cause a portion of a displayed image to be made transparent to reveal a second image, as though the second image was hidden underneath. This layering technique may be especially useful for working with animations or video. The instructions for the display element may be transmitted by the security proxy server 1608 for rendering by a web browser or application based on detected coordinates of a pointer position. In other instances, the security proxy server 1608 may receive pointer coordinates from the client device 1602 and accordingly transmit additional instructions and/or display elements to change an appearance of the displayed element.

As discussed herein, a pointer file defines how a pointer is to be displayed and moved. The pointer file may for example, include or reference an image file that is to replace an arrow image of a pointer with another graphical representation. As one can appreciate, the pointer file may reference virtually any shape, design, or graphical representation of a pointer. In some embodiments, the security proxy server 1608 may transmit one or more instructions for updating an operating system (“OS”) pointer rather than sending a pointer file for a webpage or an application.

In some instances, a hot spot of a pointer may be moved to a center of a graphical representation of the pointer to provide better responsiveness from a user. Further, in some embodiments, the pointer hot spot may be provided at an offset from the display element, as discussed above, to counter bots or malicious applications that are attempting to control a pointer at a client device.

As disclosed herein, challenge text corresponds to one or more prompts that are provided to a user for answering a challenge. The challenge text may be included within a file and/or one or more messages transmitted from the security proxy server 1608. In other embodiments, the challenge text is included within the display element file.

The example security proxy server 1608 is configured to use one or more answer files associated with a challenge to determine if a user/bot provided a correct answer. The answer files may be computed based on a challenge's UI control parameters and/or historical usage data. The answer file may include one or more coordinates and/or grid locations representative of a pointer being moved to a specified target location on a display element. In some embodiments, a user has to make a pointer selection, causing the selection coordinates to be transmitted to the server 1608 for comparison to the answer file. In other instances, the server 1608 may receive a stream of data that is indicative of pointer position and compare the stream to the answer file. The data may include sensor data or a position of the pointer that is determined from the sensor data. The stream of point positions may also correspond to when a user makes a pointer selection. These instances may correspond to challenges where a user is prompted to use the pointer to draw a shape/figure with the pointer over a display element by tilting the client device 1602. One or more of the coordinates from the stream of data is compared to one or more coordinates within the answer file to determine if the user drew the correct shape or moved the pointer in the specified manner.

In an example, a challenge could prompt a user to make a dancer in a display element do a dance called the floss. To answer the challenge correctly, a user has to select an arm of the dancer in the display element, which causes the arm (and also possibly the hips and legs) to become animated. The user then has to move in the arm in the correct manner corresponding to the ‘floss’ dance move by tilting the client device 1602. Coordinates of the pointer position (or data from the sensor 1603) are returned to the server 1608 and compared to an answer file to determine if the user moved the pointer in the correct back-and-forth manner at least a certain number of times.

In some embodiments, a challenge may be associated with a time threshold and/or a click threshold. The thresholds may be stored in separate files and/or included within an answer file. The time threshold corresponds to an amount of time a user is given to answer a challenge. The time threshold may be 10 seconds, 30 seconds, 1 minute, 5 minutes, etc. The server 1608 may begin a timer when the proxy server 1608 transmits the challenge to the client device 1602. The server 1608 ends the timer when a response message is received from the client device 1608 including, for example, a pointer selection and corresponding pointer coordinates or grid identifiers (e.g., a location of a hot spot of a pointer when a user pressed a selection key on a mouse or similar input device) with respect to a display element. If a response is received before the threshold, the response is compared to an answer. If a response is provided after the threshold, the server 1608 may provide another challenge, transmit an error to the client device 1602, and/or transmit an alarm or alert to the application server 1604. In some embodiments, two thresholds may be configured. If a response is received between the two thresholds, a second challenge is generated. If a response is received after the second threshold, the proxy server 1608 may cause the session to end, such as by closing a browser or sending an instruction to the application server 1604 to end a session with a client device.

Additionally or alternatively, the security proxy server 1608 may use one or more click thresholds. The thresholds ensure that a bot cannot return a significant number of pointer selections within a short time period in an attempt to randomly select the correct location. For example, the server 1608 may be configured such that a first received pointer selection is used for comparison to an answer. Later received selections are configured to be disregarded. In other embodiments, the server 1608 may compare the first two, three, five or ten pointer selections for comparison to the answer file. In addition, the server 1608 may 1608 may compare a time difference between the selections. The server 1608 may determine whether the pointer selections are received less than 0.25, 0.5, 1.0, or 2.0 seconds apart (e.g., a threshold time). The server 1608 generates an error indicative of a detection of a bot or malicious application if the selections are made within the time threshold. In addition, reception of a number of selections greater than a threshold may cause the server 1608 to generate an error message for the client device 1602 and/or the application server 1604.

In some embodiments, the challenges may be created manually by an operator. For example, an operator can select a display element, any feedback or animation features of the display element, coordinates or grid size, and/or pointer file information/graphical representation. The operator may then select one or more coordinates/pixels/grid locations that correspond to a correct answer. The operator may also select timer/click thresholds. The operator may also create text providing a prompt or challenge instruction to a user.

In other embodiments, the server 1608 is configured to automatically generate the challenges. For example, the server 1608 may have access to a library of images and/or videos. Further, the server 1608 may have access to images of items and/or graphical representations of pointers. The server 1608 selects an image, optionally adds one or more items from other images, and creates a coordinate space and/or grid for the display element. The server 1608 may also select a graphical representation for the pointer. In some embodiments, the server 1608 performs one or more image analysis routines, searches for metadata, and/or otherwise identifies content of an image. The server 1608 may also perform the image analysis or metadata analysis for selecting a graphical representation of a pointer. The graphical representations may include metadata or text that identifies the image and/or use of the image for selection in creating a challenge prompt.

The server 1608 uses the graphical representation of the pointer and/or the results of the image analysis/metadata analysis to create or determine a challenge prompt. For example, upon identifying a person in a picture, and selecting a soda can, the server 1608 may 1608 may select or create a message that indicates a descriptor of the graphical representation should be placed on a body part of the person. The server 1608 may access, for example, a database that links different descriptors of items, display elements, and/or graphical representations of pointers to one or more phrases, actions, instructions, etc.

In some embodiments, the display element, items within a display element, and/or graphical representation of a pointer may be selected for marketing or commercial value. For example, a sponsor, such as a manufacturer of soda, may request that the graphical representation of the pointer include an image of the manufacturer's product. Additionally or alternatively, the items within a display element may include promotional material or promoted individuals. In an example, a challenge for purchasing concert tickets may show an image of a performer related to the performance. Such tie-ins increase a user's engagement with the challenge while making the challenge seem less burdensome, or even fun. Further, the use of commercialized products or individuals enables a website host to monetize the challenge.

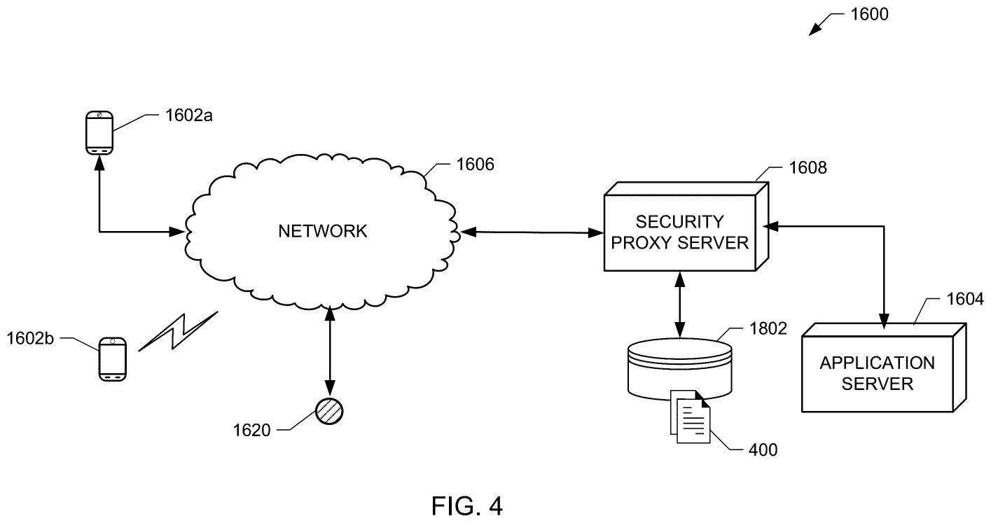

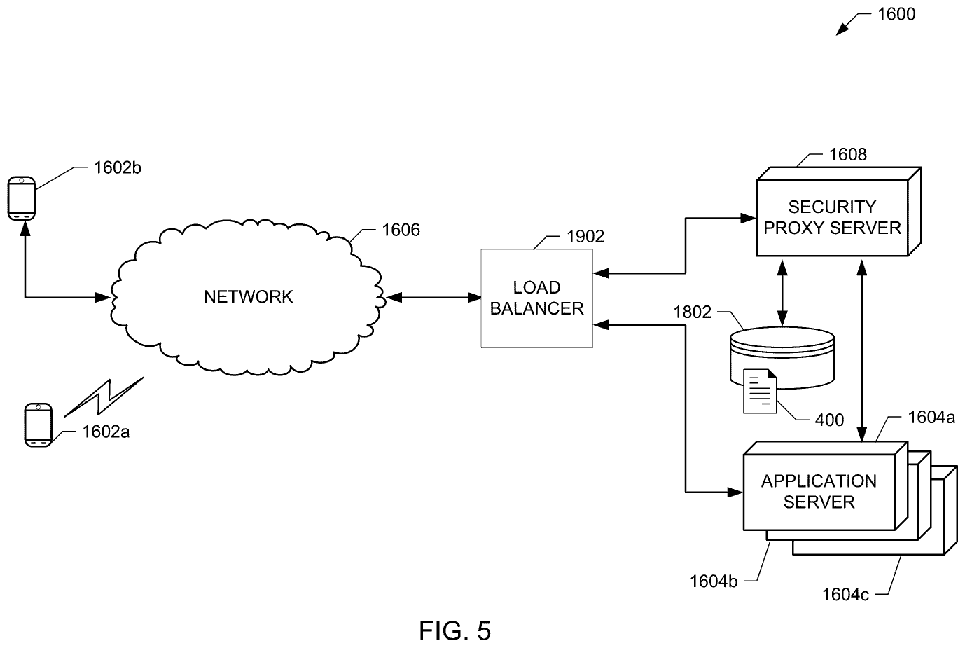

FIGS. 4 and 5 show additional examples of the example environment 1600 of FIGS. 2 and 3, according to example embodiments of the present disclosure. FIG. 4 shows an example where the security proxy server 1608 is provisioned between the application server 1604 and the network 1606. The client devices 1602 include web browsers or applications for interfacing with the application server 1604. In addition, the malicious application 1620 is configured to interface with the application server 1604. The security proxy server 1608 is configured to provide one or more challenges for portions of the website that include sensitive information or known to be typically abused by bots. As such, the security proxy server 1608 only permits human users to access critical content from the application server 1604.

In some embodiments, the security proxy server 1608 is communicatively coupled to a database 1802 (e.g., a memory device). The example database 1802 is configured to store a plurality of challenges (e.g., challenge files 400). Each of the challenges may specify a display element (or an identifier or link to a display element), a user prompt, pointer information, and a location of the display element that corresponds to a correct response. The security proxy server 1608 is configured to identify one or more webpages or application calls that are designated as being critical where a challenge is desired. The server 1608 accordingly injects or otherwise adds at least some information from a selected challenge file to the webpage or application for transmission to the client devices 1602.

FIG. 5 shows an example of the environment 1600 in which a load balancer 1902 is provisioned between the servers 1604 and 1608 and the network 1606. The load balancer 1902 is configured to provide electronic load balancing to point incoming requests from the client devices 1602 to internal recourses that are provided by one or more application servers 1604. The load balancer 1902 is also configured to transmit responses from the servers 1604 to the appropriate endpoint at the client devices 1602. In some instances, the load balancer 1902 may include a HTTP/HTTPS listener, one or more gateways, and/or one or more APIs.

In the illustrated example, the security proxy server 1608 is configured to provide security for only a portion of the webpages or application features that are hosted or made available by the application server 1604. For the remainder of the webpages or application content, transmissions bypass the server 1608 and are routed by the load balancer 1902 directly to the application server 1604. The load balancer 1902 may be configured to determine whether a request from the client device 1602 is to be routed to the server 1608 by, for example, comparing the request to a data structure that identifies (e.g., rules that define criteria for message routing) which request types are to be forwarded to the server 1608. The application server 1604 may be configured to route certain responses to the server 1608 instead of the client device 1602 based on response type. For example, responses that include a webpage with a challenge (e.g., transmission of a key session resource) may be routed to the security server 1608. The key session resource may include, for example, authentication pages, adding-to-cart pages, purchase pages, completion pages, etc., which are favorite targets for client-side fraud and abuse by bots. In some examples, the server 1608 is configured to operate with the load balancer 1902 at network layers 4 to 7 of the OSI model. It should be appreciated that two load balancers may be used instead of one. A first load balancer may be provisioned to handle incoming traffic from client devices. A second load balancer may be configured to handle outbound traffic from the application server 1604.

In some embodiments, the server 1608 may be provisioned as an auto-scaling group to take advantage of cloud computing reliability and handle dynamic increases at load, such as when concert tickets go on sale.

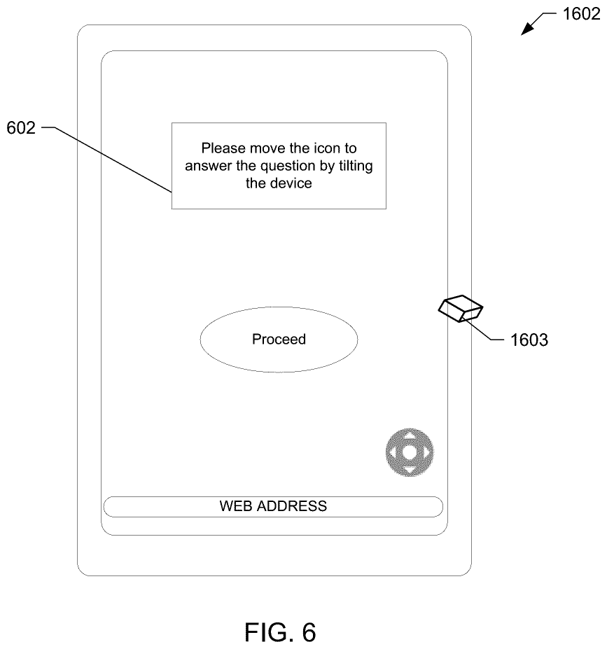

FIGS. 6 to 9 show diagrams of a Turing test 602 that is provided by the servers 1604 and 1608 of FIGS. 2 to 5 to a client device 1602, according to an example embodiment of the present disclosure. In this example, the Turing test 602 includes an initial prompt that provides direction to a user. Here, the prompt instructs a user to move an icon or a pointer to a target location. When the user is ready, they select the ‘Proceed’ button by selecting the corresponding location of the touchscreen of the client device 1602.

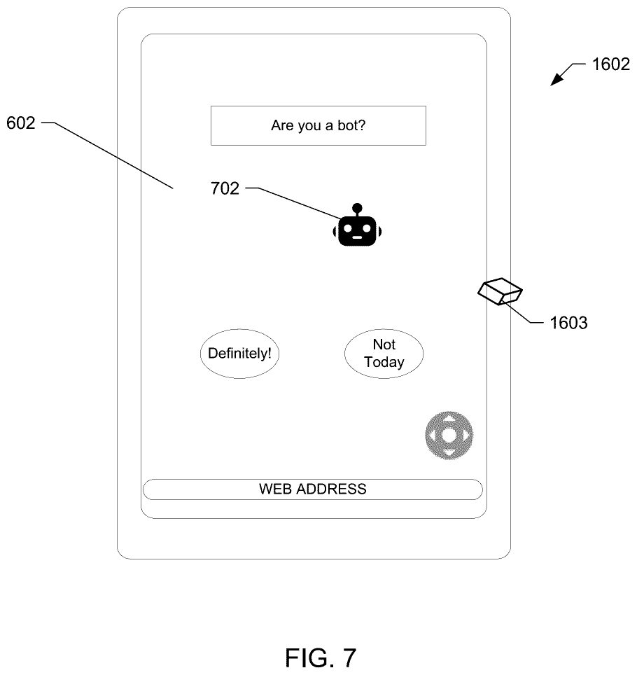

FIG. 7 shows another user interface for the Turing test 602, which is displayed by the client device 1602. The Turing test 602 includes a prompt that questions whether the user is a bot. The Turing test 602 also displays a pointer 702 as a graphical representation of a robot head. The Turing test 602 also specifies that movement of the pointer 702 is based on a tilt of the client device 1602. In other words, movement inputs for the pointer 702 are associated with sensor data from the inertial and/or acceleration sensors 1603.

For example, tilt along a positive roll axis for two seconds may translate to moving the pointer 702 by 200 pixels of movement to the right side of the screen of the client device 1602. In another example, tilt along a negative pitch axis for three seconds may translate to moving the pointer 702 by 300 pixels toward a top of the screen. Further, the degree of tilt may correspond to different pointer movement speeds. For example, each 10° of tilt per second may correspond to movement of 100 pixels per second, such that 30° of tilt held for one second causes the pointer 702 to move 300 pixels per second. The sensitivity for each axis may be specified by the Turing test 602.

To complete the test, the Turing test 602 provides two answers, “Definitely!” (wrong answer) and “Not Today” (correct answer). The “Not Today” icon is associated with a hot spot or target location. To successfully solve the Turing test 602, the pointer 702 has to be moved to the “Not Today” icon by tilting the user device 1602. During this time, the user device 1602 records, for example, a duration of time to complete the Turing test 602 and a movement path that was taken to reach the target location. The movement path may be specified by screen coordinates and/or pixel locations of the client device 1602. Additionally or alternatively, the movement path may include data from the sensors 1603, such as angle of rotation over time. The movement information may be added to a starting location of the pointer 702 to provide dead reckoning positioning.

In some embodiments, the Turing test 602 may include a timeout threshold, such as ten seconds, twenty seconds, thirty seconds, etc. After this time, the Turing test 602 is ended as an unsuccessful completion. The Turing test 602 may specify a timer that is to be displayed to give the user an indication of how much time is remaining to complete the test.

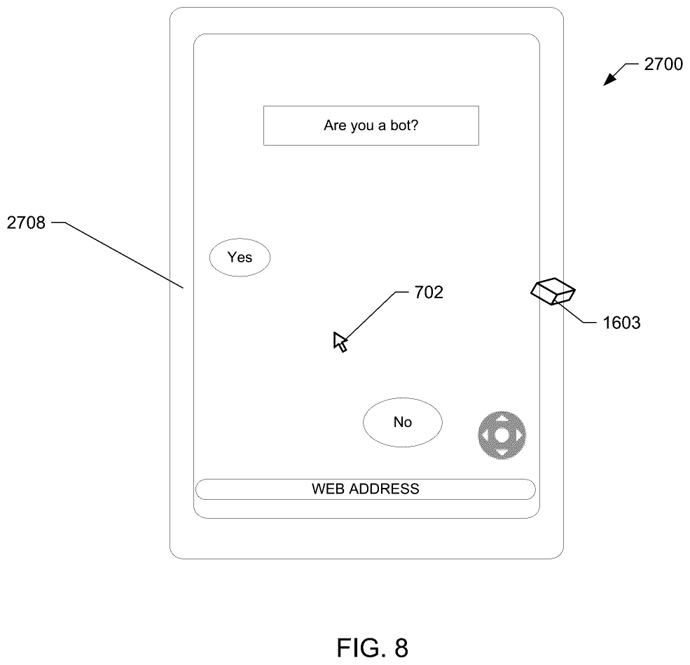

FIG. 8 shows another example of a user interface of the Turing test. In this example, the pointer 702 includes an arrow icon. Further, the answers include “Yes” and “No”. Further, the locations of the answers are moved to different parts of the screen, thereby providing additional variability between the Turing tests 602. In some embodiments, the Turing test 602 may also specify a background image, animation, or other content that is to be displayed as part of the challenge.

In one instance, the content may include a game-like challenge, such as tilting the client device 1602 to move the pointer 702 through a maze to reach the correct answer. In another instance, the content may include a puzzle-based challenge. For example, the challenge may prompt a user to select and move a puzzle piece to a particular location. The piece is moved by tiling the client device 1602. Further, the piece may be rotated and/or flipped by rotating and/or flipping the client device 1602.

In some embodiments, the challenge includes definitions that specify how tilt or other movement information translates into pointer movement. In the above-examples, the tilt or movement of a mouse translates approximately into the same movement for the pointer 702. However, in some instances, movement or tilt in a certain direction causes movement in another direction. Further, the speed of movement may cause a change in direction. For example, moving a mouse upwards (or tilting the client device 1602 a certain direction) slowly causes the pointer 702 to be moved upward slowly in a corresponding manner. However, moving the mouse upward (or tilting the client device 1602 a certain direction) in a fast manner causes the pointer 702 to move downward or to the left, for example, slowly or quickly. The number of translations and challenge variability are endless.

The security proxy server 1608 is configured based on the idea that the automated bot can decipher images and possible known movement. However, the challenge used by the security proxy server 1608 is configured to use real-time human intuition that cannot be easily trained. As such, for challenges where a human can quickly figure out the translation between movement/tilt of the client device 1602 (or a mouse) and the pointer 702, an automated bot is not capable of determining the UI input mechanisms that cause the pointer 702 to move to the target location.

In other instances, the prompted movement includes shaking the client device 1602 or moving the client device 1602 along one or more linear axes. For example, the Turing test 602 may relate a position of the user to the pointer 702 such that the user has to walk forward, backward, and/or to the side with the client device 1602 (or more easily move the client device 1602 forward and/or to the side) to cause the pointer 702 to move. The movement is measured by the sensors 1603 and provided within a response that is transmitted from the client device 1602 to the security proxy server 1608 for comparison to one or more answers or correct responses stored within the corresponding challenge file 400.

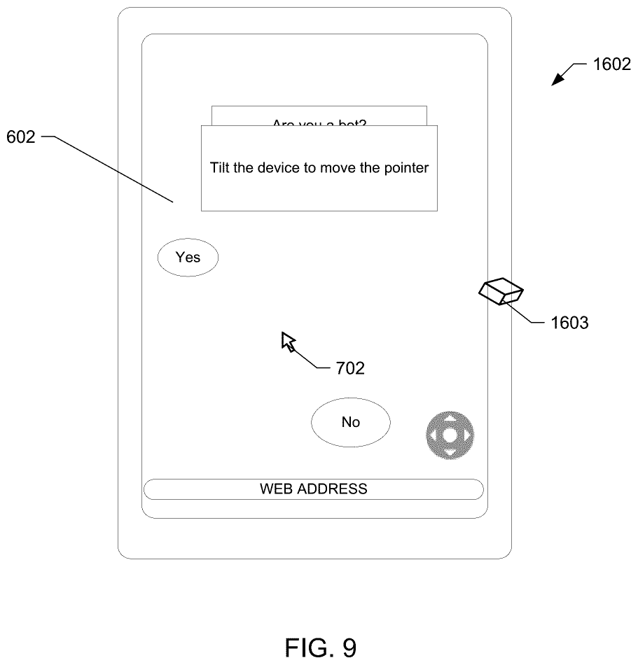

FIG. 9 shows a user interface that is displayed by the Turing test 602 to provide the user additional prompts. Here, the Turing test 602 may receive touchscreen input data from the client device 1602 that indicates the user is attempting to touch or move the pointer 702 with this finger. In response, the Turing test 602 displays a prompt that instructs the user to tilt the client device 1602 to move the pointer 702. Since movement inputs to the pointer 702 are associated with the sensor data, touch inputs do not affect movement of the pointer 702. However, in some embodiments, the Turing test 602 may include touchscreen inputs for confirming an end of a movement path or to select an icon as a hot spot after the pointer 702 has been moved to the hot spot.

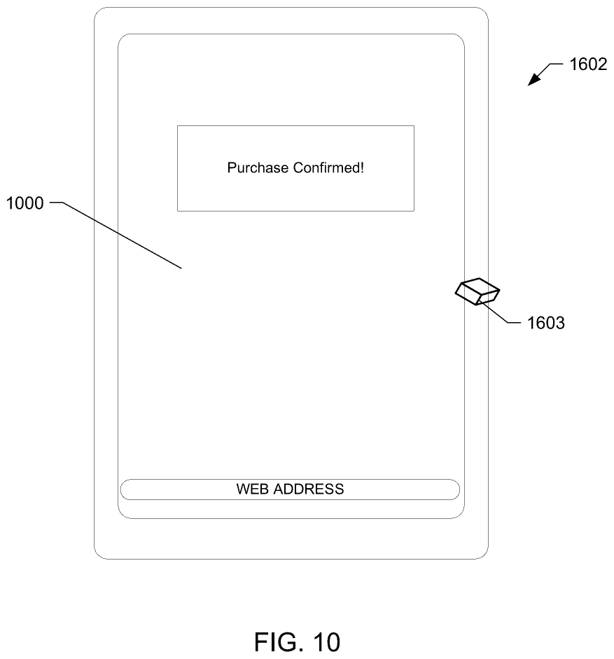

FIG. 10 shows a diagram of a user interface 1000 that is displayed by the client device 1602 after the Turing test 602 has been successfully completed. In some embodiments, the security application 1702 and/or the security proxy server 1608 provides a successful completion message to the application server 1604, which then causes the user interface 1000 to be displayed. This may also include processing a transaction or logging into or navigating to a restricted website.

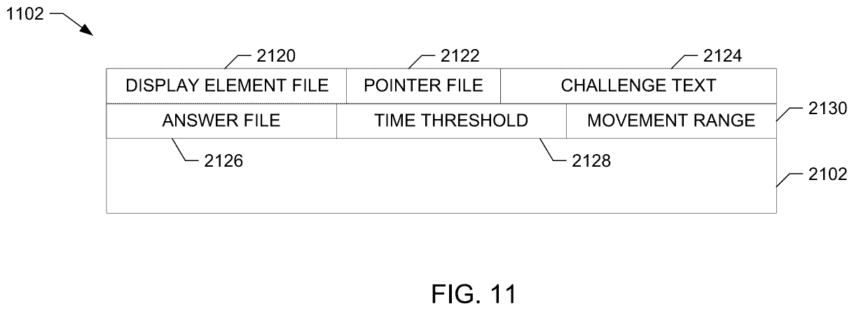

FIG. 11 is a diagram of a data structure or database 1102 that is used by the security proxy server 1608 or the security application 1702 to determine whether a Turing test 602 was successfully completed. The database 1102 includes, for example, a challenge data structure 2102 (e.g., a challenge file) for each Turing test selected and/or created. A challenge data structure 2102 may be created for each user/session that receives a challenge and/or a challenge data structure 2102 may be created to store a challenge for inclusion in a webpage or application.

The data structure 2102 may include one or more files or a single file. When the structure 2102 includes more than one file, the files may be organized by a folder or index. In some embodiments, the data structure 2102 may include links to files stored at other locations in the database 1802.

The data structure 2102 includes a display element file or partition 2120, a pointer file or partition 2122, challenge text 2124, an answer file or partition 2126, a time threshold 2128, and a movement range 2130. The display element file or partition 2120 includes an image and/or one or more items for display of a Turing test 602. Alternatively, the display element file or partition 2120 may include an identifier of a display element or a file link or hyperlink to a display element. The file or partition 2120 may be coded in a format for inclusion within webpage code. The file or partition 2120 may include active elements for pointer interaction and/or a coordinate/grid. The pointer file or partition 2122 includes parameters for displaying a pointer. The parameters may include a link to a graphical representation, a hot spot location, movement/visual characteristics of a pointer, and/or tilt sensitivity information. In some embodiments, the pointer file or partition 2122 may be replaced by pointer instructions for updating an OS pointer.

The data structure 2102 also includes challenge text that is displayable to provide instructions or prompts to a user. In some instances, the challenge text may be stored to the display element file or partition 2120. The data structure 2102 may also include an answer file or partition 2126. The example answer file or partition 2126 is configured to store one or more coordinates or grid identifiers that are indicative of a successful selection or response from a user. The coordinates and/or grid may be specified as to whether they are compared to pointer selections and/or pointer movement information. The answer file or partition 2126 may also contain one or more coordinates or grid identifiers that are indicative of an unsuccessful selection or response from a user. In some embodiments, the answer file or partition 2126 may include messages or actions to be performed based on whether a user's response is deemed correct or incorrect.

The time threshold 2128 includes one or more time limits for receiving a response message from a user. The movement range 2130 specifies acceptable movement paths that are indicative of human users. The movement range 2130 may be specified by screen coordinates, pixel locations, and/or sensor data. When sensor data is used, the data is formatted based on types of angular and/or linear acceleration sensors included within the client device 1602 that receives the Turing test.

The movement range 2130 may include a length limit in some embodiments. Movement of a pointer over the length limit may indicate a bot that is random or systematically providing sensor data to mimic tilting of the client device 1602 without knowing the target location. In some instances, the displayed target location is shown as an offset from a coded target location. The movement range 2130 may define the offset such that a human user would include the offset in their movement data while an automated bot would not identify the offset.

In other embodiments, the movement range 2130 may define keep out areas that a user is not likely to move the pointer for reaching a target location. Further, the movement range 2130 may include more granular data, such as a smoothness of a movement path, where too smooth and too random paths are deemed associated with automated bots. In some further embodiments, the movement range 2130 may include a machine learning algorithm that compares the movement path to a path classification system that is trained with known bot and human user movement information.

It should be appreciated that the answer file or partition 2126 or the data structure 2102 may include a link or reference to another challenge. In other embodiments, the data structure 2102 may include multiple challenges that have to be solved by a user. In some instances, the challenges are sequential such that a second challenge cannot be provided until the first challenge is successfully solved.

In addition to above, the Turing test 602 may include input from other input devices. For example, movement of the pointer 702 may be tied to movement of a smartwatch, an e-ring, or a mouse. The input device may be communicatively coupled to the client device 1602 via a wireless link, such as Bluetooth®.

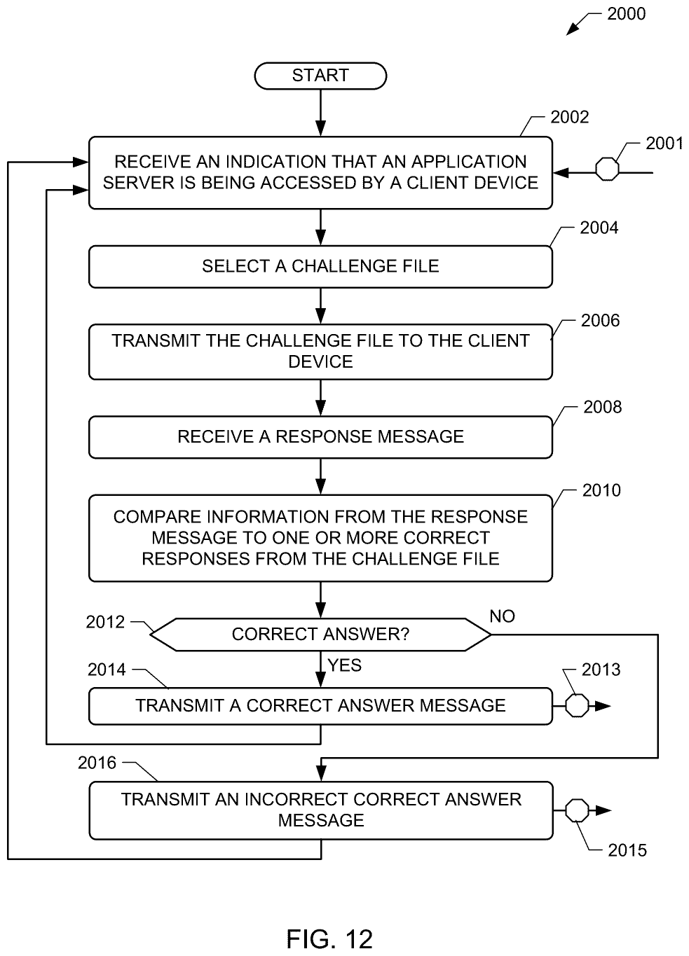

FIG. 12 is a flow diagram illustrating an example procedure 2000 to administer the Turing test 602 to a client device, according to an example embodiment of the present disclosure. The example procedure 2000 may be carried out by, for example, the security application 1702 and/or the security proxy server 1608 discussed above. Although the procedure 2000 is described with reference to the flow diagram illustrated in FIG. 12, it should be appreciated that many other methods of performing the functions associated with the procedure 2000 may be used. For example, the order of many of the blocks may be changed, certain blocks may be combined with other blocks, and many of the blocks described are optional. For example, multiple Turing tests 602 may be administered for a challenge.

The procedure 2000 begins when the security application 1702 and/or the security proxy server 1608 receives an indication (e.g., a request message 2001) that an application server is being accessed by a client device (block 2002). The security application 1702 and/or the security proxy server 1608 selects a challenge file from along a plurality of challenge files (block 2004). The security application 1702 and/or the security proxy server 1608 then transmits the selected challenge file to the client device (block 2006).

The challenge file may specify a challenge for a webpage or application hosted by the application server. The challenge file prompts a user to, for example, tilt their client device in a certain manner to move a pointer or icon to a certain target location (e.g., a pointer hot spot). The movement of the pointer is configured as though the pointer is being pulled downward by gravity such that the angular orientation of the client device dictates the movement of the pointer. Data from one or more angular acceleration sensors and/or linear acceleration sensors within the client device is stored to a response message and used to confirm that the client device was tilted as intended to reach the specified target location. In some embodiments, the sensitivity of the Turing test may be varied between sessions to make it more difficult for an automated bot to leverage pre-recoded human input data.

In some instances, the Turing test can change how the data from the one or more angular acceleration sensors and/or linear acceleration sensors is associated with movement of a pointer. For example, the Turning test can reverse the correspondence between tilt and pointer movement so a user would have to tilt a client device in an opposite manner to move the pointer as intended. Additionally or alternatively, the Turing test can change the movement speed based on a distance from a target location and/or a location on a screen of a client device. This movement change might make the test appear more ‘jerky’ to a user and make it more difficult for a bot to solve. In an example, the Turing test can specify that a pointer is to move slower as it approaches a target location despite the client device having a same tilt or linear movement. In other examples, the correspondence may vary over time or between sessions.

In some embodiments, the Turing test disclosed herein includes the use of a pointer file that changes an appearance of a pointer from an arrow to a graphical representation of another object. Examples include a soda can, a beer bottle, a game controller, sunglasses, a hat, a bird, a dog, etc. As one can appreciate, the examples of graphical representations are virtually endless. The Turing test also includes or specifies a page display element, such as a picture, animation, or video. The page display element is configured to have coordinates or other location information. For a given challenge, the challenge file specifies coordinates that satisfy or solve the challenge and coordinates that correspond to an incorrect answer. The coordinates for solving a challenge for a given display element are stored to the challenge file beforehand based on the image or video selected for display, and how display element relates to the graphical representation of the pointer based on an operating system of the client device.

The display element may include a scenery picture, a picture of a person, such as an actor or musician, a picture of multiple people, etc. The display element may be selected in coordination with the graphical representation of the pointer and a challenge provided to a user. The challenge includes one or more instructions that requests a user to move the pointer to a certain location on a display element. The requested location is configured to be easily discernable by a user but extraordinarily difficult for a bot or malicious application to answer. The challenges represent real-time comprehension of UI device input and output effects and acquired internal human knowledge that is not easily parameterized by a computer.

The example challenge file may further complicate the challenge by causing at least portions of a display element to change in response to a pointer hover or movement. For example, the challenge file may cause at least a portion of a display element to zoom in, zoom out, animate, change to a different displayed element, change in perspective, change a display of an item within the display element, and/or uncover or make transparent a first image or color to reveal an underlying image. The change in display of at least a portion of the display element is readily discernable by a user but extremely difficult for a bot or other malicious application to process.

As shown in FIG. 12, the procedure 2000 continues when a response message is received in the security application 1702 and/or the security proxy server 1608 (block 2008). The response message may include coordinates of a pointer selection and/or pointer movement information, which corresponds to data from one or more angular and/or linear acceleration sensors of the client device. The pointer movement can be tracked and stored to the response message to determine if the movement is within established patterns of human usage for a given layout, task, and UI control parameters (how much angle of tilt is required for a given movement in terms of pixels) indicative of a human user or a brute force pixel by pixel row by row scanning pattern or more sophisticated other pattern aided by the inclusion of AI, which is indicative of a bot.

The security application 1702 and/or the security proxy server 1608 compares information within the response message to one or more correct responses that are stored in conjunction with the selected challenge file (block 2010). Based on the comparison, the security application 1702 and/or the security proxy server 1608 determines whether the user provided a correct answer (block 2012). When the information within the response message matches or is included within the location corresponding to the correct response for the selected challenge file, the security application 1702 and/or the security proxy server 1608 transmits a correct answer message 2013 to the application server (block 2014). In response to the correct answer message 2013, the application server permits the client device to access content or carry out/complete a transaction. When the information within the response message does not match or is not included within the location corresponding to the correct response for the selected challenge file, the security application 1702 and/or the security proxy server 1608 transmits an incorrect answer message 2015 to the application server (block 2016). In response to the incorrect answer message 2015, the application server prevents the client device from accessing content or carry out/completing a transaction. The example procedure 2000 then returns to block 2002 for a next challenge/session.

In the above embodiments, challenges for bot deterrence are provided for operations with various webpages and/or applications. The challenges may be completed relatively quickly by a human, while at the same time being insolvable by a bot within an allotted time. The challenges and framework disclosed herein enable content or application providers to provide robust website/application bot countermeasures, and in some cases, a source of additional revenue through security-based advertisement placement.

### CONCLUSION

It will be appreciated that all of the disclosed methods and procedures described herein can be implemented using one or more computer programs or components. These components may be provided as a series of computer instructions on any computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

For some embodiments of the disclosed technology, including those depicted in the figures, the soft presentation information of the pointer may be dependent on time since start of session, user interactions, (x,y) position while preserving the look and feel of the original page, preserving functionality of the original page, and therefore preserving the hard information of the session/application. For some embodiments of the disclosed technology, including those depicted in the figures, the soft response information of the pointer may also be dependent on time since start of session, user interactions, and (x,y) position, while preserving the look and feel and functionality of the original page. For some embodiments of the disclosed technology, including those depicted in the figures, soft information changes of the page/application environment in which the pointer acts may also be enabled subject to the constraints that the hard information required for the client and server to transmit and receive data in order to fulfill the intended use case of the application are preserved.

One or more aspects or features of the subject matter described herein can be realized in digital electronic circuitry, integrated circuitry, specially designed application specific integrated circuits (“ASICs”), field programmable gate arrays (“FPGAs”) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include client devices and servers. A client device and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (“PLDs”), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

To provide for interaction with a user, one or more aspects or features of the subject matter described herein can be implemented on a computer having a display device, such as for example a cathode ray tube (“CRT”) or a liquid crystal display (“LCD”) or a light emitting diode (“LED”) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

The invention is claimed as follows:

1. A security system comprising:
a memory device storing a plurality of challenge files for determining if a webpage user is a human or a bot, each of the challenge files including a display element, a user prompt, pointer information, and a location of the display element that corresponds to a correct response, the pointer information specifying how data from angular or linear sensors of client devices is to move a pointer or icon on the client devices;
a security proxy server communicatively coupled to the memory device, the security proxy server configured to:
receive an indication message that a webpage of an application server is to be transmitted to a client device,
select a challenge file from the memory device,
transmit at least some information from the challenge file to cause the display element and the user prompt to be displayed on the client device and a pointer to be moved as specified by the pointer information responsive to data from angular or linear sensors of the client device,
receive a response message corresponding to at least one of a pointer selection or pointer movement made by the pointer at the client device in relation to the display element,
compare information within the response message to the location corresponding to the correct response for the selected challenge file,
when the information within the response message matches or is included within the location corresponding to the correct response for the selected challenge file, transmit a correct answer message, and
when the information within the response message does not match or is not included within the location corresponding to the correct response for the selected challenge file, transmit an incorrect answer message.

2. The apparatus of claim 1, wherein the pointer information includes specifying how fast the pointer is to move based on a degree of tilt of the client device.

3. The apparatus of claim 1, wherein the pointer information includes specifying how fast the pointer is to move based on a movement speed of the client device.

4. The apparatus of claim 1, wherein the security proxy server is configured to transmit the correct answer message to the application server, which causes the application server to at least one of transmit the webpage to the client device, transmit a second webpage to the client device, or transmit content related to the webpage to the client device.

5. The apparatus of claim 1, wherein the security proxy server is configured to transmit the incorrect answer message to the application server, which causes the application server to at least one of terminate a connection to the webpage with the client device, terminate a session with the client device, or block the client device.

6. The apparatus of claim 1, wherein the incorrect message includes at least some information from another challenge file that is selected by the security proxy server for display on the client device.

7. The apparatus of claim 1, wherein the display element and the user prompt are displayed in the webpage or in a popup window over the webpage.

8. The apparatus of claim 1, wherein the display element is specified in at least one of an image file, a video file, an audio file, a multimedia file, a java file, or a plug-in file, and wherein the display element shows at least one item comprising a person, an animal, a character, a scene, or a vehicle.

9. The apparatus of claim 8, wherein the display element includes instructions that cause at least part of the shown item to change in appearance in response to a mouse-over or hover by the pointer in relation to a location of the item shown in the display element.

10. The apparatus of claim 1, wherein locations of the display element are specified by coordinates and the location of the correct response includes at least one of a coordinate or a set of coordinates.

11. The apparatus of claim 1, wherein the pointer information includes at least one of a pointer file or instructions for changing properties of the pointer at the client device.

12. The apparatus of claim 1, wherein the pointer information is specified to correspond to the respective display element of the challenge file.

13. The apparatus of claim 1, wherein the challenge file includes a time threshold, and the security proxy server is further configured to:
start a timer when the challenge file is provided;
when the response message is received before the elapsed time of the timer has reached the time threshold, perform the comparison that uses the information within the response message; and
when the elapsed time of the timer has reached or exceeded the time threshold, determine a challenge associated with the challenge file was not successfully completed and provide at least one of the incorrect message or a timeout message.

14. The apparatus of claim 1, wherein the challenge file includes a click threshold, and the security proxy server is further configured to:
receive sequential multiple response messages, each response message including a location of the pointer during a pointer selection;
perform the comparison using the information within the earliest, sequentially received response messages that are below or meet the click threshold; and
disregard the response messages that sequentially exceed the click threshold.

15. The apparatus of claim 1, wherein the response message includes an identifier of the selected challenge file, and wherein the identifier is used to determine the location of the display element that corresponds to the correct response.

16. The apparatus of claim 1, wherein the response message includes pointer movement information corresponding to the data from the angular or linear sensors of the client device, and
the security proxy server is configured to compare the pointer movement information within the response message matches to the location corresponding to the correct response for the selected challenge file.
